(19) United States
(12) Patent Application Publication
(10) Pub. No.: US 2026/0208613 A1
(43) Pub. Date: Jul. 23, 2026

(54) CHARGING AN ELECTRIC WORK VEHICLE

(71) Applicant: Caterpillar Inc., Peoria, IL (US)

(72) Inventors: Thomas Leslie TWIGGER, Spalding, Lincolnshire (GB); Shelby Elaine SPIVEY, Raleigh, NC (US)

(21) Appl. No.: 19/145,092

(22) PCT Filed: Dec. 13, 2023
(86) PCT No.: PCT/US2023/083717

§ 371 Date: Jul. 1, 2025

(30) Foreign Application Priority Data
Jan. 6, 2023 (GB) 2300223.1

(51) Int. Cl. B60L 53/66; B60L 53/62; B60L 53/68

(52) U.S. Cl. CPC B60L 53/66; B60L 53/62; B60L 53/68; B60L 2200/40; B60L 2250/12; B60L 2250/16

(57) ABSTRACT

Using a charging module to charge a battery of an electric work machine. When the charging module receives an instruction to start charging the battery, power draw from the charging module is increased from zero to a power limit value, at a rate of change of power draw. In the event an output of a user interface is received, which includes a user-specified power ramp rate value, the rate of change of power draw is the user-specified power ramp rate value. In the event the received output of the user interface does not comprise a user-specified power ramp rate value or an output of the user interface is not received, the rate of change of power draw is a default power ramp rate value. The method further comprises charging the battery at the power limit value until actual state of charge of the battery reaches a maximum state of charge.

### FIELD OF THE DISCLOSURE

The disclosure relates to the field of charging electric work vehicles or construction machines.

### BACKGROUND

An electric work vehicle may comprise a storage battery that is charged with power using an external vehicle charging apparatus comprising a charging module. A ramp rate may be used to define a rate of increase in power draw by the electric work vehicle from the charging module. Conventionally, many electric work vehicles default to a fast charge scenario, assuming that the operator wants the vehicle to be ready for use as soon as possible. Under a fast charge scenario, the ramp rate may be set to a high ramp rate to increase the power draw as fast as possible. However, in locations where power supply is unreliable or variably reliable, this may lead to unwanted interruptions or inefficiencies in the power supply. As such, many charging modules used in locations where power supply is unreliable or variably reliable default to a lower than maximum ramp rate setting to accommodate the lowest periods of reliability. This in turn may lead to the charging module at times charging the electric work vehicle slower than may otherwise be possible.

The charging module for charging an electric work vehicle may be a remote charging module (e.g. a battery or a generator) or part of a wider energy distribution network. The reliability of the charging module may depend on several factors. The reliability may be variable, meaning that at times the power supply is reliable and at other times the power supply is less reliable.

In an example where the power module is part of a wider energy distribution network, demands on the energy distribution network from other devices or components may reduce the availability of power to charge an electric work vehicle. In this example, the reliability may vary based on how the energy distribution network is used. For example, there may be lower demands on the energy distribution network at night or at other particular times.

In an example where the power supply is from a battery associated with the charging module, the state of charge of the battery associated with the charging module may affect the ability of the charging module to supply power to the electric work vehicle. In this example, the reliability of the power supply may vary based on prior usage of the charging module.

In another example where a charging module is powered by an internal power supply associated with the charging module, where the internal power supply is powered by e.g. an energy resource such as combustible fuel, nuclear fuel, wind, solar, or some other energy resource, then the availability of the energy resource may affect the ability of the charging module to supply power. In this example, the reliability of the power supply may vary based on e.g. the amount of fuel available or e.g. the weather conditions.

In some examples where a charging module is useable at more than one location, the reliability of the power supply may depend on the location. In this example, the reliability of the power supply may vary based on the particular locations, e.g. the typical weather conditions or energy infrastructure at the particular location.

In these examples, drawing power from the charging module at the maximum ramp rate by the electric work vehicle at times when the power supply is unreliable may cause interruptions in the supply of power from the charging module, the wider energy distribution network, and/or otherwise reduce the efficiency of supplying power to the electric work vehicle.

### SUMMARY

Against this background there is provided a method for charging a battery of an electric work vehicle using a charging module. According to the method, in response to an instruction to charge the battery, a power draw from the charging module is increased from zero to a power limit value, at a rate of change of power draw, where: in the event that an output of a user interface is obtained and the output comprises first data comprising a user-specified power ramp rate value, the rate of change of power draw is the user-specified power ramp rate value; and in the event that an output of the user interface is obtained and the output of does not comprise first data comprising a user-specified power ramp rate value or an output of the user interface is not obtained, the rate of change of power draw is a default power ramp rate value. And the battery is charged at the power limit value until an actual state of charge of the battery reaches a maximum state of charge value.

In this way, a power supply from a charging module to an electric work vehicle may be adapted to the circumstances and the risk of an interruption in the power supply from the charging module may be reduced.

The following disclosure also provides a device for controlling the charging of a battery of an electric work vehicle using a charging module. An instruction to charge the battery is obtained and in response power draw from the charging module is increased from zero to a power limit value, at a rate of change of power draw, where: in an event that an output of a user interface is obtained and the output comprises first data comprising a user-specified power ramp rate value, the rate of change of power draw is the user-specified power ramp rate value; and in an event that an output of the user interface is obtained and the output does not comprise first data comprising a user-specified power ramp rate value or an output of the user interface is not obtained the rate of change of power draw is a default power ramp rate value. The controller providing for charging of the battery at the power limit value until an actual state of charge of the battery reaches a maximum state of charge value.

### BRIEF DESCRIPTION OF THE DRAWINGS

A specific embodiment of the disclosure will now be described, by way of example only, with reference to the accompanying drawings in which:

FIG. 1 shows a charging module connected to an electric work vehicle and optionally also to other devices;

FIG. 2 shows an energy distribution network for connecting a charging module to an electric work vehicle;

FIG. 3 shows an example of a charging module;

FIG. 4 shows a first example of an electric work vehicle, wherein a user interface is part of the electric work vehicle;

FIG. 5 shows a second example of an electric work vehicle where a user interface is provided separately to the electric work vehicle; and

FIG. 6 show a process for increasing power draw at a ramp rate value, and drawing power at or below a power limit value for charging an electric work vehicle, in accordance with embodiments of the disclosure.

### DETAILED DESCRIPTION

According to an embodiment of this disclosure, there is a method of charging a battery 121 of an electric work vehicle 120 by a charging module 110.

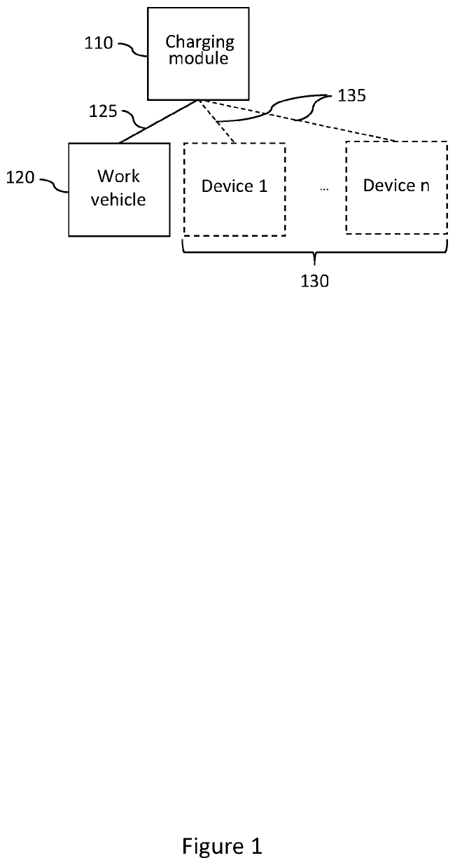

FIG. 1 shows a charging module 110 connected to an electric work vehicle 120 to supply power to the electric work vehicle 120 in order to charge a battery 121 of the electric work vehicle 120. The charging module 110 is connected to the electric work vehicle 120 via connection lines 125 capable of transferring power between the charging module 110 and the electric work vehicle 120. The connections may be permanent or may be changeable. As is appreciated by those skilled in the art, the connection lines 125 may comprise any component capable of transferring power. The charging module 110 may also be connected to one or more other devices 130 via further connection lines 135.

In examples relevant to this disclosure, when charging of the battery 121 of the electric work vehicle 120 initiated, a power output to the vehicle 111 of the charging module 110 increases its power output to a power limit, wherein the rate of increase in the power output to the vehicle 111 is known as a power ramp rate.

The charging module 110 may itself comprise a power source for supplying power to the electric work vehicle 120 and any other devices 130 that may be connected to the charging module 110. In this way, a charging module 110 may provide power at a remote location.

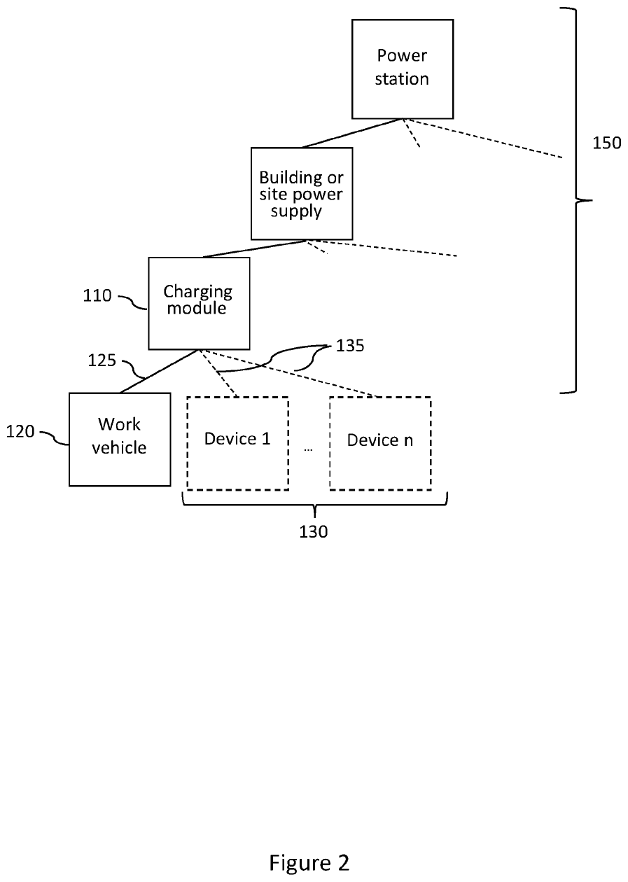

FIG. 2 shows an energy distribution network 150 to which the charging module 110 may be connected. As shown in FIG. 2, the charging module 110 may receive power which ultimately originates from a power source such as a power station within the energy distribution network 150. A principal function of the energy distribution network 150 may be to distribute power from a power source (e.g. a power station) to a number of locations and devices. The energy distribution network 150 may be a large energy distribution network (e.g. the National Grid in the United Kingdom) or may be a local energy distribution network (e.g. a building or a worksite). In some examples, the energy distribution network may be at a remote location. In this way, the energy distribution network 150 may supply power to the charging module 110 for supplying power to the work vehicle 120 and, where present, to other devices 130.

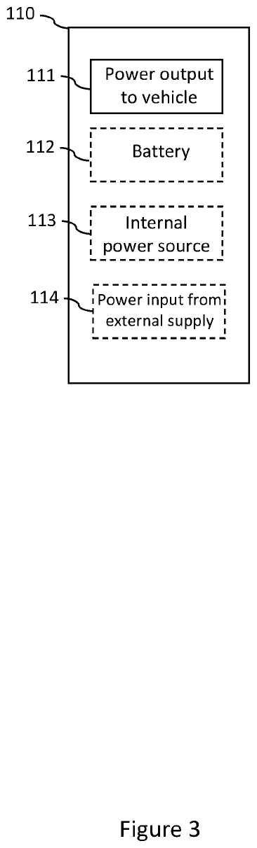

FIG. 3 shows an example of a charging module 110. The charging module 110 comprises a power output 111 for outputting power to an electric work vehicle 120 in order that the charging module 110 may charge a battery 121 of the electric work vehicle 120. The charging module 110 may obtain power from one or more internal sources, one or more external sources or a combination of both. In the example of FIG. 3, the charging module 110 may comprise one or more of a power input from an external supply 114 (for example, the energy distribution network 150 of FIG. 2), a battery 112 and a generator 113. The generator 113 may, for example, comprise a diesel generator, a solar cell, a wind turbine, a nuclear reactor or any other suitable feature for providing electrical power.

As will be appreciated by the skilled person, a charging module 110 according to the above noted examples may facilitate charging of an electric work vehicle 120 at either a remote location where the charging module is not connected directly to an energy distribution network 150 or at a location where the charging module is connected directly to an energy distribution network 150. In some examples, the charging module 110 may at times be connected and at times disconnected from an energy distribution network 150 e.g. a battery 112 of a charging module 110 may be charged and then used to charge a battery of an electric work vehicle 110 at a remote location.

An electric work vehicle 120 comprises a battery 121 for storing energy supplied by the charging module 110 and a power input 123 for receiving power from the charging module 110 to supply power to the battery 121 of the electric work vehicle 120. An electric work vehicle 120 which may be charged according to this disclosure is associated with a user interface 122 for controlling the charging.

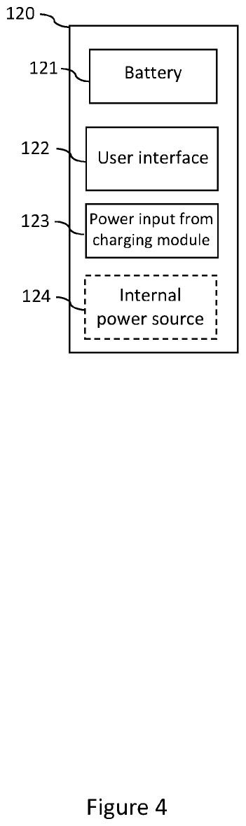

FIG. 4 shows a first example of an electric work vehicle 120, wherein a user interface 122 is part of the electric work vehicle 120. In the example of FIG. 4, a display in a cab of the electric work vehicle 120 may comprise the user interface 122.

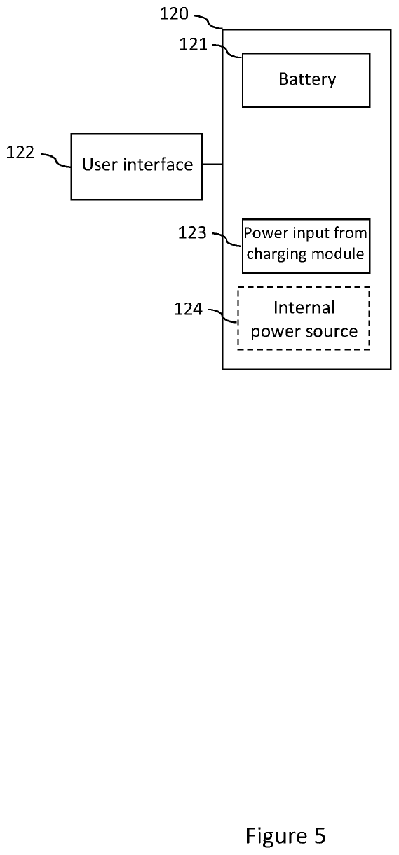

FIG. 5 shows a second example of an electric work vehicle 120 where a user interface 122 is provided separately to the electric work vehicle 120. In the example of FIG. 5, a remote electronic device may comprise the user interface 122. The remote electronic device may comprise a mobile device or a smartphone. The remote electronic device may communicate wirelessly with the electric work vehicle 120.

In any of the above exemplary user interfaces 122, the user may interact with the device in any suitable way, for example by interacting with a touch-screen display, by voice command, or by using a button, switch or lever. In this way, a user may configure a charging program by inputting data to a user interface 122.

The electric work vehicle 120 may comprise an internal power source 124 in addition to the battery 121. The internal power source 124 may be an internal combustion engine, for example if the electric work vehicle 120 is a hybrid electric work vehicle. The internal power source 124 may generate electrical power, and/or generate mechanical power.

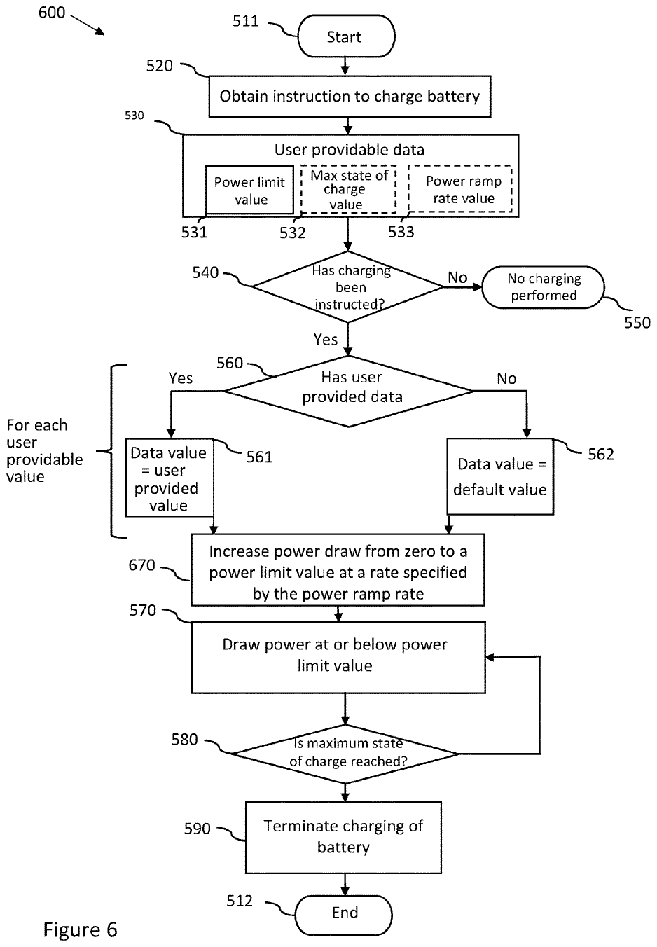

FIG. 6 show a process for increasing power draw at a ramp rate value, and drawing power at or below a power limit value for charging an electric work vehicle 120 in accordance with an embodiment of the disclosure.

In a first step 520 an instruction to charge the battery 121 of the electric work vehicle 120 is obtained. In a second step 530, an output from a user interface 122 is obtained. The data output from the user interface 122 may comprise one or more values which are relevant to the charging program. As will be explained further below, where a value is providable by the user interface 122 (user providable data), the user may or may not provide a value using the user interface according to their particular need. Where a data value is providable by the user interface 122 and/or is required by the charging program but the data value is not provided by the user, a default data value is used. In the example shown in FIG. 6, the data output from the user interface 122 comprises first data 531 that is indicative of a user-specified power limit value and optionally comprises second data 532 that is indicative of a maximum state of charge value. The obtaining of the instruction to charge the battery 121 and the obtaining of user providable data may be performed in any particular order prior to beginning the charging of the electric work vehicle 120.

In a third step 540, whether to charge the battery is evaluated based on the instruction obtained in the first step 520. If no charging is required by the instruction obtained in the first step 520, the method may be terminated in a fourth step 550. In some examples where the instruction to charge comprises a charging schedule, the third step 540 may re-evaluate whether charging has been instructed in order to charge the battery 121 according to the charging schedule.

In some examples, the instruction may be obtained automatically in response connection the electric work vehicle 120 to the charging module 110. For example, a handshake may take place to confirm the vehicle has been connected for charging before any steps to initiate drawing power from the charging module 110 to charge the battery 121 of the electric work vehicle 120 begin. In some examples, the instruction may be set to begin charging according to a particular charging schedule, for example a charging schedule which is calibrated to ensure an appropriate state of charge is reached by the time the electric work vehicle 120 is required for use. In some examples, the instruction to charge may be a switch or other input initiated by the user. In some examples, the instruction may be obtained by an output from the user interface 122, which may allow the user to issue a timed or delayed instruction to charge the battery 121. In any of the above examples a timed, delayed, or scheduled instruction to charge the battery 121 of the electric work vehicle 120 may prevent exerting an excessive load on an energy distribution network 150 which may in turn prevent unwanted interruption in the supply of power from the charging module 110, or to other parts of an energy distribution network 150.

If charging is required by the instruction obtained in the first step 520, a fifth step 560 evaluates whether a user has provided data for any piece of user providable data. In the example shown in FIG. 6, the user providable data comprises first data 531 indicative of a power limit value and optionally further comprises second data 532 indicative of a maximum state of charge and/or optionally further comprises third data 533 indicative of a power limit value.

Where a data value is providable by the user interface 122, and a data value has been provided by the user, the data value is set to the data value provided by the user in a step 561. Where a data value is providable by the user interface 122 but no data value is provided, the data value is set to a default data value in a step 562. In this way, each data value providable by a user in step 530 may be assigned as a default value or as the user-specified value depending on whether the data has been provided by the user. In examples where a data value is required but is not providable by a user, the data value is set to a default value throughout.

In a sixth step, the power is increased from zero to a value at or below the power limit value at a rate specified by the power ramp rate value.

In a seventh step 570, the method continues drawing power at or below the power limit value. In an eighth step 580, whether the maximum state of charge value has been reached is evaluated. If the maximum state of charge value has not been reached, the method continues to draw power to charge the battery 121 of the electric work vehicle 120 in the seventh step 570. If the maximum state of charge value has been reached, the charging of the battery is terminated in a final step 590. In some examples, the final step 590 comprises setting the power ramp rate value to the default power ramp rate value after the battery 121 is disconnected from the charging 110 module. In some examples, the final step comprises setting other user provided data (e.g. the maximum state of charge value, and/or the power limit value) to the default maximum state of charge value.

In this way the power drawn by charging the electric work vehicle 120 by the charging module 110 is controllable by a user interface 122. As such, it is possible to avoid situations where an excessively high power is drawn, which may lead to power supply interruptions. In addition, it is possible to avoid situations where an unnecessarily low power is drawn, which may lead to charging time or efficiency reductions. Excessively high ramp rates may be avoided when the internal or external power supply to the charging module 110 is less reliable, which may lead to fewer interruptions in the power supply from the charging module 110. Excessively low power ramp rates may be avoided when the power supply is more reliable, which may result in the power supply from the charging module 110 more quickly taking advantage of the available power when power supply.

In the examples where the data output from the user interface 122 includes a maximum state of charge value, the user may select a maximum state of charge value which is beneficial for increasing the reliability of the power supply from the charging module 110. For example, a lower maximum state of charge value may be selected to prevent overloading the power supply which may prevent unwanted interruption in the supply of power from the charging module 110, or to other parts of an energy distribution network 150 to which the charging module 110 may be connected. Additionally, the user may select a maximum state of charge value which is beneficial for taking advantage of increased reliability of the power supply.

The data vales may be provided by a user to the user interface 122 in any of the following ways. Once a data value has been provided by a user to the user interface 122, the data value may then be outputted for use in the above described method 600 for charging a battery 121 of an electric work vehicle 120 using a charging module 110.

In examples where the user provides first data 531 indicative of a power ramp rate value, the first data 531 indicative of a power ramp rate value may be provided by a user to a user interface 122 in the following ways. In a first example, the first data 531 may be user-selectable in response to a selection from a range of power ramp rate values via an input of the user interface 122. As a second example, the first data 531 may be obtained via an input of the user interface 122 from either a list of power ramp rate values and/or a scale of power ramp rate values. As a third example, the first data 531 may be user-selectable in response to a selection of a power ramp rate mode via an input of the user interface 122. The power ramp rate mode may be selected from a list of power ramp rate modes comprising one or more of a lower power ramp rate mode, a normal power ramp rate mode, and a high power ramp rate mode. As will be appreciated, the first data 531 may be obtained by a combination of the above examples.

In examples where a user does not provide first data 531 indicative of a power ramp rate, a default power ramp rate may be used. In one example, the default power ramp rate may be a maximum power ramp rate corresponding to a maximum load of the battery 121 of the electric work vehicle 120. In another example, the default power ramp rate may be below the maximum load of the battery 121 of the electric work vehicle 120.

In examples where a user provides first data 531 indicative of a power ramp rate value, the power ramp rate value may be set to the default power ramp rate value after the battery 121 is disconnected from the charging module 110.

In some examples, a user may provide second data 532 indicative of a maximum state of charge value. In examples where the user provides second data 532 indicative of a maximum state of charge value to a user interface 122, the second data 532 indicative of a maximum state of charge value may be provided by a user to the user interface 122 in the following ways. As a first example, the second data 532 may be user-selectable from a range of maximum state of charge values via an input of the user interface 122. As a second example, the second data 532 may be user-selectable via an input of the user interface 122 from either a list of maximum state of charge values and/or a scale of maximum state of charge values. As a third example, the second data 532 may be user-selectable in response to a selection of a maximum state of charge mode via an input of the user interface 122. The maximum state of charge mode may be selected from a list of maximum state of charge modes comprising one or more of a lower state of charge mode, a normal state of charge mode, and a high state of charge mode. As will be appreciated, the second data 532 may be user-selectable by a combination of the above examples.

In examples where a user does not provide second data 532 indicative of a state of charge of the battery, a default state of charge of the battery may be used. In one example, the default maximum state of charge may be the maximum capacity of the battery 121 of the electric work vehicle 120. In another example, the default maximum state of charge of the battery 121 of the electric work vehicle 120 may be a value below the maximum capacity of the battery 121 which may be beneficial for long-term storage of the battery 121, health of the battery 121, energy efficiency, and/or cost of charging efficiency.

In examples where a user provides second data 532 indicative of a maximum state of charge value, the maximum state of charge value may be set to the default maximum state of charge value after the battery 121 is disconnected from the charging module 110.

In some examples, a user may provide third data 533 indicative of a power limit value. In examples where the user provides third data 533 indicative of a power limit value, the first data 533 indicative of a power limit value may be provided by a user to a user interface 122 in the following ways. As a first example, the third data 533 may be user-selectable from a range of power limit values via an input of the user interface 122. As a second example, the third data 533 may be user-selectable from either a list of power limit values and/or a scale of power limit values. As a third example, the third data 533 may be user-selectable in response to a selection of a power mode via an input of the user interface 122. The power mode may be selected from a list of power modes comprising one or more of a lower power charging mode, a normal power charging mode, and a high power charging mode. As will be appreciated, the third data 533 may be user-selectable by a combination of the above examples.

In examples where a user does not provide third data 533 indicative of a power limit value, a default power limit value may be used. In some examples, the default power limit value may be the maximum power limit value available from the charging module 110. In some examples, the default power limit value may be lower than the maximum power limit value.

In examples where a user provides third data 533 indicative of a power limit value, the power limit value may be set to the default power limit value after the battery 121 is disconnected from the charging module 110.

In some examples, a device for controlling the charging of an electric work vehicle 120 by a charging module 110 may be provided for carrying out the above noted examples. The device may be part of the electric work vehicle 120, the charging module 110, or any other device capable of issuing commands to the electric work vehicle 120 and charging module 110 and receiving data from a user interface 122.

1. A method for charging a battery of an electric work vehicle using a charging module, the method comprising:
obtaining an instruction to charge the battery;
in response to the instruction to charge the battery, increasing a power draw from the charging module from zero to a power limit value, at a rate of change of power draw, wherein:
in an event that an output of a user interface is obtained and the output comprises first data comprising a user-specified power ramp rate value, the rate of change of power draw is the user-specified power ramp rate value; and
in an event that:
an output of the user interface is obtained and the output does not comprise first data comprising a user-specified power ramp rate value; or
an output of the user interface is not obtained;
the rate of change of power draw is a default power ramp rate value; and
charging the battery at the power limit value until an actual state of charge of the battery reaches a maximum state of charge value.

2. The method of claim 1, further comprising:
setting the rate of change of power draw to the default power ramp rate value after the battery is disconnected from the charging module.

3. The method of claim 1, wherein an output of the user interface is obtained and the output comprises second data that is indicative of the maximum state of charge value.

4. The method of claim 1, wherein the output comprises first data in response to selection of a power mode via an input of the user interface.

5. The method of claim 4, wherein the power mode is selected from a list of power modes comprising one or more of a low ramp rate charging mode, a normal ramp rate charging mode and a high ramp rate charging mode.

6. The method of claim 1, wherein the output comprises first data in response to a selection from a range of power ramp rate values via an input of the user interface.

7. The method of claim 1, wherein the output comprises first data in response to a selection via an input of the user interface from either: a list of power ramp rate values; or a scale of power ramp rate values.

8. The method of claim 1, wherein a display in a cab of the electric work vehicle comprises the user interface.

9. The method of claim 1, wherein a remote electronic device comprises the user interface.

10. The method of claim 9, wherein the remote electronic device comprises one of: a mobile device; a smartphone; and a display of the charging module.

11. The method of claim 9, wherein the remote electronic device communicates wirelessly with the electric work vehicle.

12. The method of claim 1, wherein the power ramp rate value is lower than a maximum power ramp rate of the battery.

13. The method of claim 1, wherein the maximum state of charge value is smaller than a maximum capacity of the battery.

14. The method of claim 1 wherein:
in an event that an output of the user interface is obtained and the output comprises third data that is indicative of a user-specified power limit value, the power limit value is the user-specified power limit value, and
in an event that:
an output of the user interface is obtained and the output does not comprise third data that is indicative of a user-specified power limit value; or
an output of the user interface is not obtained;
the power limit value is a default power limit value.

15. A device for controlling charging a battery of an electric work vehicle using a charging module, wherein the device comprises a controller configured to:
obtain an instruction to charge the battery;
in response to an instruction to charge the battery, increase a power draw from the charging module from zero to a power limit value, at a rate of change of power draw, wherein:
in an event that an output of a user interface is obtained and the output comprises first data comprising a user-specified power ramp rate value, the rate of change of power draw is the user-specified power ramp rate value; and
in an event that:
an output of the user interface is obtained and the output does not comprise first data comprising a user-specified power ramp rate value; or
an output of the user interface is not obtained;
the rate of change of power draw is a default power ramp rate value; and
charge the battery at the power limit value until an actual state of charge of the battery reaches a maximum state of charge value.
